(19) United States
(12) Patent Application Publication
(10) Pub. No.: US 2023/0131239 A1
(43) Pub. Date: Apr. 27, 2023

(54) IMAGE INFORMATION GENERATING APPARATUS AND METHOD, AND COMPUTER-READABLE STORAGE MEDIUM

(71) Applicants: NTT Communications Corporation, Tokyo (JP); 3i, Inc, Seoul (KR)

(72) Inventor: Ken KIM, Seoul (KR)

(73) Assignees: NTT Communications Corporation, Tokyo (JP); 3i, Inc, Seoul (KR)

(21) Appl. No.: 18/145,888

(22) Filed: Dec. 23, 2022

Related U.S. Application Data
(63) Continuation of application No. PCT/JP2021/018534, filed on May 17, 2021.

(30) Foreign Application Priority Data
Jul. 1, 2020 (JP) 2020-114270

(51) Int. Cl. G06T 19/00

(52) U.S. Cl. CPC G06T 19/00

(57) ABSTRACT

Image information appropriately representing the state of changes in the three-dimensional space is generated. According to one embodiment, a server device (SV) stores, in an omnidirectional image storage unit (21), omnidirectional images of a three-dimensional space photographed at a plurality of positions, for each floor of a facility. Where two images of the same floor photographed at different dates and times are displayed for comparison, an omnidirectional image whose photography position coordinates are closest to the photography position coordinates of a comparison reference image is selected from among all omnidirectional images to be compared. The angle of the selected omnidirectional image to be compared is adjusted such that it corresponds to the angle of a comparison reference image. Comparison display image data is generated in which the adjusted comparison image and the comparison reference image are arranged side by side and is transmitted to the user terminal (UT1).

### CROSS REFERENCE TO RELATED APPLICATIONS

This application is a Continuation Application of PCT Application No. PCT/JP2021/018534, filed May 17, 2021 and based upon and claiming the benefit of priority from Japanese Patent Application No. 2020-114270, filed Jul. 1, 2020, the entire contents of all of which are incorporated herein by reference.

### FIELD

Embodiments described herein relate generally to an image information generating apparatus and method for use in a system that manage facilities by using, for example, images of a three-dimensional space of the facilities, and a non-transitory computer-readable storage media for storing programs.

### BACKGROUND

In recent years, techniques have been proposed for managing facilities, such as business facilities, offices and residences using images. For example, Patent Literature 1 describes a technique in which a three-dimensional (3D) image showing the inside of a facility is generated by photographing a three-dimensional space of the facility in all directions (360°) at a plurality of different positions, recording the obtained images in a storage medium, and connecting the recorded images. The use of this technique enables a facility manager or a user to remotely grasp the state of the facility from the 3D images without the need to go to the site.

### Patent Literature

### Patent Literature 1: U.S. Pat. Application Publication No. 2018/0075652

Construction sites, interiors of living spaces, etc. change with the passage of time, and there is a need for managing these changes by using images. Conventionally, however, images of the same space corresponding to a plurality of specified dates and times are merely selected from a storage medium and displayed side by side. For this reason, if the photographing conditions of the images photographed at a plurality of dates and times are different, for example, if photography positions, photographing directions, magnifications, etc., are different, it is difficult for the manager or user to accurately grasp the changes from the images simply displayed side by side.

The present embodiment has been made with the above circumstances taken into consideration, and one aspect is to provide a technique for generating image information capable of appropriately expressing how the state of changes is in a three-dimensional space.

In order to solve the above problem, an image information generating apparatus or an image information generating method according to one aspect employs a storage device in which omnidirectional images obtained by photographing a three-dimensional space at a plurality of photography positions and on different photographing occasions are stored in association with coordinates indicating the photography positions. Where a request is made to compare a first omnidirectional image and a second omnidirectional image both showing the three-dimensional space but respectively photographed on a first photographing occasion and a second photographing occasion, which are among the plurality of photographing occasions, a second omnidirectional image whose photography position coordinates are closest to the photography position coordinates of the first omnidirectional image is selected from among all second omnidirectional images stored in the storage device and photographed on the second photographing occasion. The display range and display orientation of the selected second omnidirectional image are adjusted such that they correspond to the display range and photographing direction of the first omnidirectional image, and a composite image in which the adjusted second omnidirectional image and the first omnidirectional image are arranged for comparison is generated and output.

According to one aspect, even if the photography positions of a comparison reference image and a comparison target image are different, a comparison target image whose photography position is closest to the photography position of the comparison reference image is selected, and the angle of the selected comparison target image is adjusted such that it corresponds to that of the comparison reference image. After these, display image information for comparing the two images is generated. Therefore, it is possible to generate image information that can appropriately represent the state of changes in the three-dimensional space.

### BRIEF DESCRIPTION OF THE DRAWINGS

FIG. 1 is a schematic configuration diagram of a system including a server device that operates as an image information generating apparatus according to one embodiment.

FIG. 2 is a block diagram showing an example of a hardware configuration of a server device employed in the system shown in FIG. 1.

FIG. 3 is a block diagram showing an example of a software configuration of the server device of the system shown in FIG. 1.

FIG. 4 is a flowchart showing an example of the procedures and contents of image information generation process executed by the server device shown in FIG. 3.

FIG. 5 is a diagram showing an example of photography positions of an omnidirectional image that used as a reference for comparison.

FIG. 6 is a diagram showing an example of photography positions of an omnidirectional image that are used as a target for comparison.

FIG. 7 is a diagram illustrating an example of display image information.

### DETAILED DESCRIPTION

Embodiments will now be described with reference to the accompanying drawings.

### One Embodiment

### Configuration Example

### 1 System

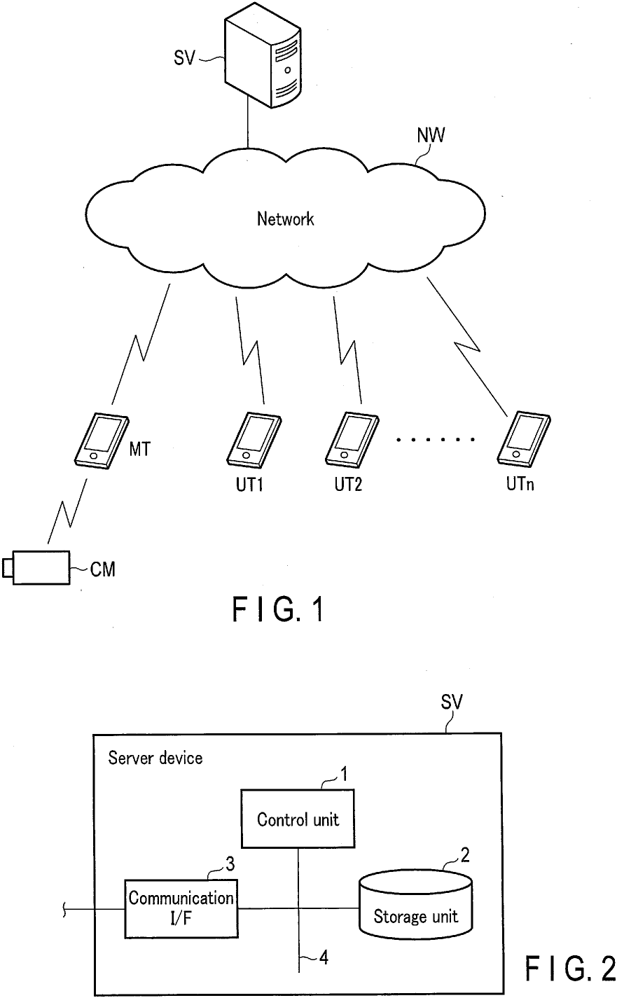

FIG. 1 is a schematic configuration diagram of a system including an image information generating apparatus according to one embodiment.

This system includes a server device SV that operates as an image information generating apparatus. Data communications are enabled between this server device SV and user terminals MT and UT1 to UTn of users via a network NW.

The user terminals MT and UT1 to UTn include a user terminal MT that is used by the user who registers omnidirectional images and user terminals UT1 to UTn that are used by users who browse the registered images. Each of the user terminals is configured as a mobile information terminal, such as a smartphone or a tablet type terminal. It should be noted that a notebook personal computer or a desktop personal computer may be used as a user terminal, and the connection interface to the network NW is not limited to a wireless type but may be a wired type.

The user terminal MT is capable of data transmission to a camera CM, for example, via a signal cable or via a low-power wireless data communication interface such as Bluetooth (registered trademark). The camera CM is a camera capable of photographing in all directions, and is fixed, for example, to a tripod capable of maintaining a constant height position. The camera CM transmits photographed omnidirectional image data to the user terminal MT via the low-power wireless data communication interface.

The user terminal MT also has a function of measuring its current position using signals transmitted, for example, from a Global Positioning System (GPS) or a wireless Local Area Network (LAN). The user terminal MT has a function of enabling the user to manually input position coordinates as a reference point in case the position measurement function cannot be used, as in the case where the user terminal MT is in a building.

Each time the user terminal MT receives omnidirectional image data photographed at one position from the camera CM, the user terminal MT calculates position coordinates indicative of the photography position, based on the position coordinates of the reference point and the moving distance and moving direction measured by built-in motion sensors (e.g., an acceleration sensor and a gyro sensor). The received omnidirectional image data is transmitted to the server device SV via the network NW together with information on the calculated photography position coordinates and photographing date and time. These processes are executed by pre-installed dedicated applications.

The user terminals UT1 to UTn have browsers, for example. Each user terminal has a function of accessing the server device SV by means of a browser, downloading an image showing how a desired place of a desired facility and floor is at a desired date and time in response to a user’s input operation, and displaying the downloaded image on a display.

The network NW is composed of an IP network including the Internet and an access network for accessing this IP network. For example, a public wired network, a mobile phone network, a wired LAN, a wireless LAN, Cable Television (CATV), etc. are used as the access network.

### 2 Server Device SV

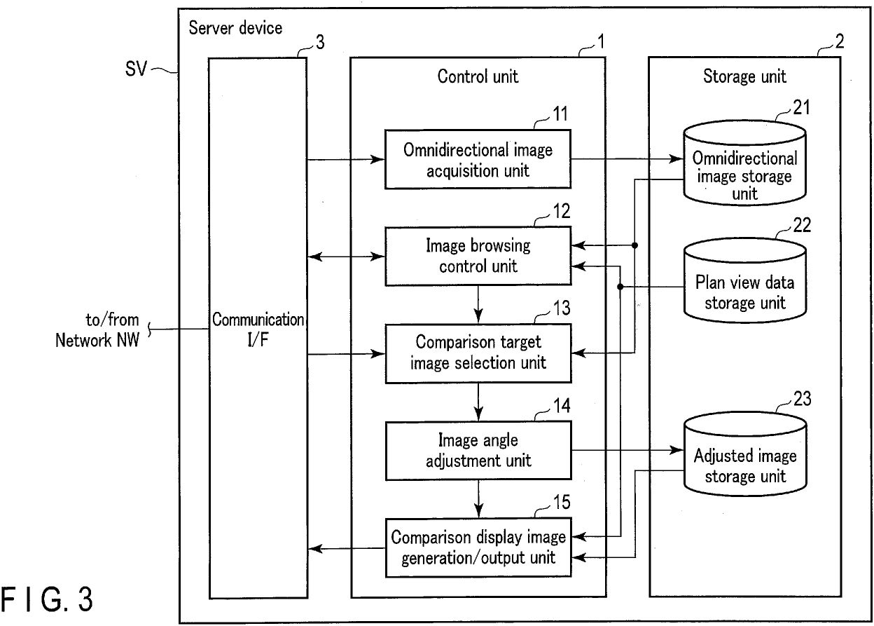

FIGS. 2 and 3 are block diagrams that show the hardware and software configurations of the server device SV, respectively.

The server device SV is composed of a server computer installed on the cloud or the Web, and includes a control unit 1 having such a hardware processor as a central processing unit (CPU). A storage unit 2 and a communication interface (communication I/F) 3 are connected to the control unit 1 via a bus 4.

The communication I/F 3 transmits and receives data to and from the user terminals MT and UT1 to UTn via the network NW under the control of the control unit 1, and uses a wired network interface, for example.

The storage unit 2 uses, for example, a nonvolatile memory, such as a Hard Disk Drive (HDD) or a Solid State Drive (SSD), which serves as a main storage medium and for which data can be written and read at any time. As the storage medium, a Read Only Memory (ROM) and a Random Access Memory (RAM) may be used in combination.

A program storage area and a data storage area are provided in the storage area of the storage unit 2. Programs necessary for executing various control processes related to one embodiment are stored in the program storage area, in addition to middleware such as an Operating System (OS) .

In the data storage area, an omnidirectional image storage unit 21, a plan view data storage unit 22 and an adjusted image storage unit 23 are provided as storage units necessary for carrying out one embodiment. In addition, a work storage unit necessary for various processes executed by the control unit 1 is provided.

The omnidirectional image storage unit 21 is used to store a group of omnidirectional images the user terminal MT acquires for each floor of a target facility. The plan view data storage unit 22 is used to store the plan view data on each floor of the target facility. The adjusted image storage unit 23 is used to store images adjusted by the comparison image adjustment process performed by the control unit 1.

The control unit 1 includes, as control processing functions according to one embodiment, an omnidirectional image acquisition unit 11, an image browsing control unit 12, a comparison target image selection unit 13, an image angle adjustment unit 14, and a comparison display image generation/output unit 15. Each of these processing units 11 to 15 is implemented by causing a hardware processor to execute a program stored in the program storage area of the storage unit 2.

Each time omnidirectional image data photographed at each of a plurality of positions in the building is transmitted from the user terminal MT, the omnidirectional image acquisition unit 11 receives the omnidirectional image data via the communication I/F 3. The received omnidirectional image data are stored in the omnidirectional image storage unit 21 in association with the information indicative of the photography position coordinates and photographing date and time which are received together with the image data.

Where an image browsing request transmitted from the user terminals UT1 to UTn is received via the communication I/F 3, an image browsing control unit 12 downloads the omnidirectional image corresponding to the request content to the request-making user terminals UT1 to UTn. Where an image comparison request is received from the user terminals UT1 to UTn, the image browsing control unit 12 performs a process of transmitting the image comparison request to the comparison target image selection unit 13.

The image comparison request may include both information designating a comparison reference and information designating a comparison target, or may include only information designating a comparison target. The former is used where the user desires to browse comparison images from the beginning, and the latter is used where the user has already browsed the comparison reference images and only a comparison target is designated.

The comparison target image selection unit 13 first selects omnidirectional images corresponding to the photographing date and time included in the information specifying the comparison target, from among all the omnidirectional images related to the specified facility name and target area stored in the omnidirectional image storage unit. Then, comparison target image selection unit 13 selects an omnidirectional image whose photography position coordinates are closest the photography position coordinates of the comparison reference image being browsed or to the photography position coordinates included in the information specifying the comparison reference from among the selected omnidirectional images.

The image angle adjustment unit 14 compares the image specified by the information specifying the comparison reference with the omnidirectional image selected by the comparison target image selection unit 13, and adjusts the angle of the omnidirectional image of the comparison target (for example, the display range and photographing direction) so that it is the same as or close to the angle of the image of the comparison reference. The adjusted image of the comparison target is temporarily stored in the adjusted image storage unit 23 together with the image of the comparison reference.

The comparison display image generation/output unit 15 reads the adjusted comparison target image stored in the adjusted image storage unit 23 and the image of the comparison reference, and synthesizes both images to generate display image data in which the images are arranged side by side. The generated display image data is transmitted to the request-making user terminals UT1 to UTn via the communication I/F 3.

### Operation Example

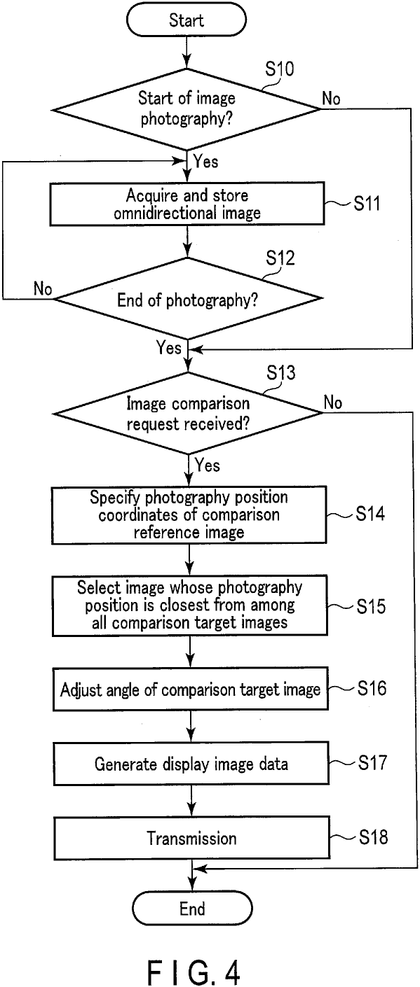

Next, an operation example of the server device SV configured as described above will be described. FIG. 4 is a flow chart showing an example of the processing procedures and processing contents.

### Acquisition of Omnidirectional Images

By way of example, let it be assumed that omnidirectional images of a number of points of a desired floor of a desired building are to be photographed and recorded. In this case, the user first uses plan view data on the building and floor of a registration target and determines a reference point from which the photographing of the floor is started. The position coordinates of the reference point are obtained based on the coordinate system of the plan view data and are entered to the user terminal MT. As a result, the position coordinates of the reference point of the target floor are set in the user terminal MT. The plan view data on the building and floor of the registration target are stored in advance in the plan view data storage unit 22 of the server device SV, and the user terminal MT can download the plan view data on the desired building and floor from the server device SV.

Then, the user operates the camera CM to photograph images in all directions at the reference point. It should be noted that the photographing operation of the camera CM may be performed remotely from the user terminal MT. Where the photographing operation is performed, the omnidirectional image data at the reference point photographed by the camera CM is transmitted to the user terminal MT, and the omnidirectional image data is transmitted from the user terminal MT to the server device SV. At this time, the user terminal MT adds information indicative of the position coordinates of the reference point and the photographing date and time to the omnidirectional image data and transmits the resultant omnidirectional image data.

After completing the photographing at the reference point, the user moves to the next photography position (photographing point) and similarly performs omnidirectional photographing with the camera CM. Where the user terminal MT receives the omnidirectional image data photographed at the new photographing point from the camera CM, the user terminal MT transmits the omnidirectional image data to the server device SV, together with information indicative of the photography position coordinates and photographing date and time. At this time, photography position coordinates are calculated based on the position coordinates set for the reference point and the movement distance and movement direction from the reference point to the new photographing point, which are measured by a distance sensor (e.g., an acceleration sensor and a gyro sensor) of the user terminal MT.

Thereafter, each time the user moves to a new photographing point and performs omnidirectional photographing with the camera CM, the user terminal MT similarly receives omnidirectional image data from the camera CM and transmits the received omnidirectional image data to the server device SV together with the photography position coordinates calculated based on the measurements of the motion sensor and information indicative of the photographing date and time.

On the other hand, the server device SV monitors the start of image photography step S10, under the control of the omnidirectional image acquisition unit 11. Upon reception of an image photography start notification from the user terminal MT, the process moves to step S11, in which the reception/storage process of omnidirectional image data is executed as below.

That is, the omnidirectional image acquisition unit 11 receives omnidirectional image data from the user terminal MT via the communication I/F 3, and causes the received omnidirectional image data to be stored in the omnidirectional image storage unit 21 in association with information received with the image data and indicative of photography position coordinates and the photographing date and time. At the same time, the omnidirectional image acquisition unit 11 plots the photography position coordinates on the plan view data on the corresponding floor stored in the plan view data storage unit 22.

Thereafter, each time omnidirectional image data is transmitted from the user terminal MT, the omnidirectional image acquisition unit 11 repeatedly executes the reception/storage process of omnidirectional image data in step S11. The reception/storage process of omnidirectional image data is ended when the omnidirectional image acquisition unit 11 detects in step S12 that the user terminal MT transmits a photographing end notification.

It should be noted that the above-described image photography includes the case where a plurality of people take images at the same date and time, and the case where the same person or different people take images at different dates and times. In either case, the images obtained by the image photography are stored in the server device SV. Each time an image is photographed, plan view data on which the photographing point is plotted is generated and stored in the plan view data storage unit 22. It should be noted that all of the above-mentioned photographing points need not be plotted, and at least one photographing point may be plotted.

### 3D Browsing Tour Using Omnidirectional Images

Where the omnidirectional images stored in the server device SV are browsed, the user activates a browser on his/her own user terminal UT1 and accesses the server device SV. In response, the server device SV first transmits a home screen under the control of the image browsing control unit 12. Where the user designates the facility name and floor number that the user wishes to browse, the server device SV transmits the plan view data on the corresponding floor under the control of the image browsing control unit 12 and displays it on the user terminal UT1.

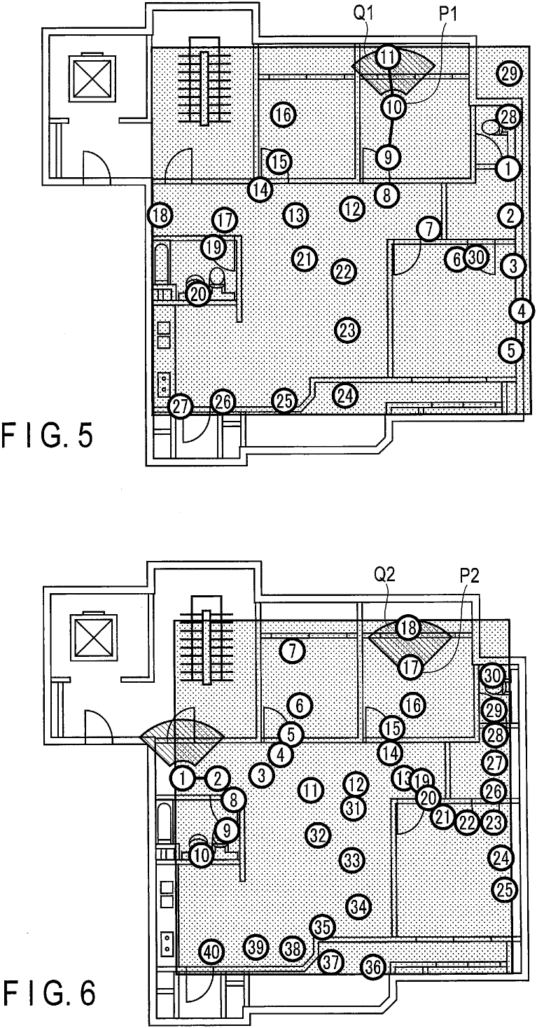

FIG. 5 shows an example of the plan view data downloaded at the time. As shown in FIG. 5, on the plan view data, the layout of a floor, photography positions (photographing points) and a photographing order are displayed, with the photographing order indicated by numbers in circles. Where the user designates an arbitrary photographing point in this state, an omnidirectional image at the photographing point is downloaded from the server device SV to the user terminal UT1. When the user changes the display orientation of the image by operating a mouse, for example, the display target range of the omnidirectional image changes over 360° in response to the operation. Where the photographing points are sequentially moved from one to another by the mouse operation, the omnidirectional images at the photographing points are sequentially downloaded and displayed. Thus, a three-dimensional browsing tour using omnidirectional images is enabled for each room on the floor.

### Selection of Images of Comparison Target

Let it be assumed that during the 3D browsing tour, the user intends to compare a currently-displayed image of an arbitrary room (an image of comparison reference) with an image of the same room taken at another date and time in the past (an image of comparison target). In this case, the user enters different photographing dates and times to the user terminal UT1. In response to this, the user terminal UT1 transmits an image comparison request designating the different photographing dates and times to the server device SV.

On the other hand, where the server device SV receives the image comparison request in step S13, the photography position coordinates of the image currently displayed by the three-dimensional browsing tour are first specified from the omnidirectional image storage unit 21 in step S14 under the control of the comparison target image selection unit 13. Subsequently, in step S15, the omnidirectional image storage unit 21 is searched, and the omnidirectional image whose photography position coordinates are closest to the photography position coordinates of the reference image is selected from among all omnidirectional images of the same floor which are photographed at the different photographing dates and times specified by the image comparison request.

For example, let it be assumed that the user is browsing an omnidirectional image taken at the photographing point P1 of “10” in FIG. 5 at the angle (display range and direction) indicated by Q1 in the Figure. Also, let it be assumed that the photographing point of the same floor at the different photographing date and time specified by the user as a comparison target is the one shown in FIG. 6. In this case, the comparison target image selection unit 13 of the server device SV selects a photographing point P2 to which the distance from the currently-browsed photographing point P1 shown in FIG. 5 is shortest from among all photographing points shown in FIG. 6.

### Angle Adjustment for Comparison Target Image

Next, in step S16, under the control of the image angle adjustment unit 14, the server device SV reads an omnidirectional image corresponding to the selected photographing point P2 from the omnidirectional image storage unit 21, and compares the read omnidirectional image of the comparison target with the display image of the comparison reference. Then, the display range and display orientation of the comparison target image are adjusted such that the angle Q2 of the comparison target image approaches the angle Q1 of the comparison reference image. In this adjustment process, the corresponding positions of the displayed comparison reference image and comparison target image are shifted in units of pixels, and a shift position is searched for where the difference value between the corresponding pixels of the comparison reference image and the comparison target image is minimum.

After the adjustment of the display range and display orientation for the comparison target image is completed, the image angle adjustment unit 14 temporarily stores the adjusted comparison target image in the adjusted image storage unit 23 in association with the comparison reference image.

### Generation And Transmission of Comparison Display Image

Subsequently, under the control of the comparison display image generation/output unit 15, the server device SV reads the comparison reference image and the comparison target image from the adjusted image storage unit 23 in step S17, and synthesizes these images with the images being arranged horizontally, thereby generating comparison display image data. At the same time, the comparison display image generation/output unit 15 superimposes floor plan view data on the comparison reference image of the comparison display image data and synthesizes them. In this plan view data, the photographing point P1 and angle Q1 of the currently-browsed image are displayed.

The comparison display image generation/output unit 15 transmits the generated comparison display image data from the communication I/F 3 to the request-making user terminal UT1 in step S18.

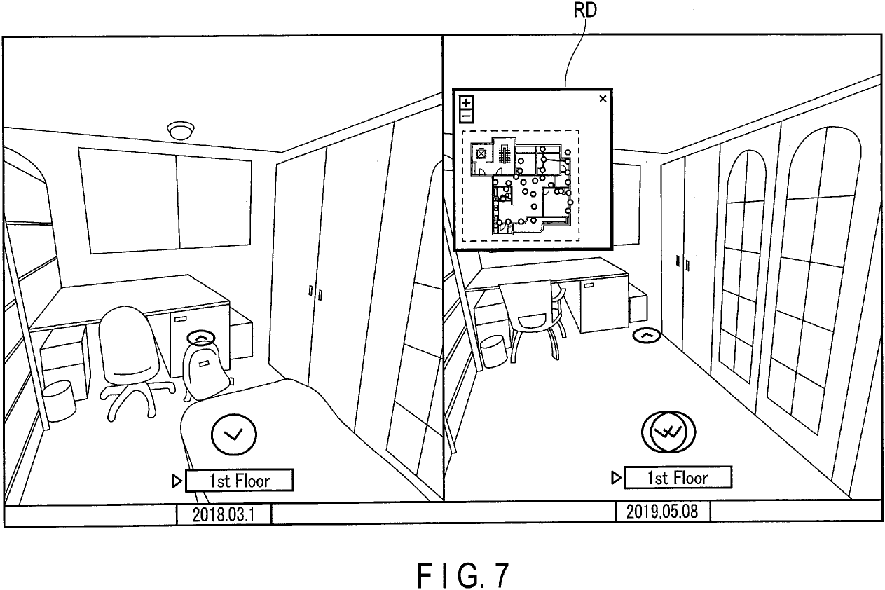

Upon the reception of the comparison display image data from the server device SV, the user terminal UT1 displays the comparison display image on the display in place of the comparison reference image that has been displayed until then. FIG. 7 shows an example of how the comparison display image looks like, and the comparison reference image is shown on the right side and the comparison target image is shown on the left side. RD in the Figure is a plan view of the floor displayed on the comparison reference image.

### Operations and Advantageous Effects

As described above, according to one embodiment, omnidirectional images obtained by photographing the three-dimensional space of each floor of the facility at a plurality of positions are stored in the omnidirectional image storage unit 21. Where two images of the same floor photographed at different dates and times are displayed for comparison, an omnidirectional image whose photography position coordinates are closest to the photography position coordinates of a comparison reference image is selected from among all omnidirectional images of comparison target. The angle of the selected omnidirectional comparison target image is adjusted such that it corresponds to the angle of the comparison reference image. Comparison display image data is generated in which the adjusted comparison target image and the comparison reference image are arranged side by side, and is transmitted to the user terminal UT1.

Therefore, according to one embodiment, even if the photography positions of a comparison reference image and a comparison target image are different, a comparison target image whose photography position is closest to the photography position of the comparison reference image is selected, and the angle of the selected comparison target image is adjusted such that it corresponds to the angle of the comparison reference image. After these, display image information for comparing the two images is generated. Therefore, the user can generate image information that can appropriately represent the state of changes in the three-dimensional space.

In addition, floor plan view data is superimposed on the comparison display image data, and the photographing point and photographing angle are displayed on the floor plan view data. Therefore, the user can confirm the photography position and photographing direction of the currently-browsed image at a glance from the plan view.

### Other Embodiments

(1) Where an omnidirectional image of comparison target does not include an image corresponding to the photography position of a comparison reference image, it is difficult to generate image data for comparing the comparison reference image and the comparison target image.

In such a case, therefore, the comparison target image selection unit 13 selects a comparison target image having the closest photography position coordinates by determining whether the distance to the photography position coordinates of the comparison reference image is equal to or greater than a predetermined threshold value. When it is determined that the distance between the photography position coordinates is equal to or greater than the threshold value, the omnidirectional image at this time is not selected as a comparison target image, and the comparison display image generation/output unit 15 is notified to that effect. The comparison display image generation/output unit 15 generates a message indicating that there is no corresponding comparison target image, and transmits this message to the user terminal UT1 and displayed. Thus, an inappropriate image is prevented from being displayed as a comparison target.

(2) In connection with the above embodiment, reference was made to the case of generating comparison display image data in which two omnidirectional images of the same place photographed at different dates and times are displayed side by side, but comparison display image data in which images of three or more different dates and times are displayed side by side may be generated.

(3) In connection with the above embodiment, reference was made to the case of generating comparison display image data in which images photographed at two different dates and times are displayed for comparison, but it is possible to generate data in which omnidirectional images of the same floor which are photographed by two users on the same day may be displayed for comparison.

(4) In connection with the above embodiment, reference was made to the example in which the function of the image information generating apparatus is provided for the server device SV, but that function may be provided for an inter-network connection device such as an edge router or for a user terminal. Alternatively, the control unit and the storage unit may be provided separately in different server devices or terminal devices, and these devices may be connected via a communication line or network.

(5) In addition, the configuration of the image information generating apparatus, the procedures and processing contents of the image generating process, the type of three-dimensional space, etc. can be variously modified without departing from the gist.

That is, the present embodiment is not limited to what was described above and can be embodied in practice by modifying the structural elements without departing from the gist. In addition, various embodiments can be made by properly combining the structural elements disclosed in connection with the above embodiments. For example, some of the structural elements may be deleted from the embodiments. Furthermore, structural elements of different embodiments may be combined properly.

### REFERENCE SIGNS LIST

SV: server device
MT, UT1-UTn: user terminal
NW: network
CM: camera
1: control unit
2: storage unit
3: communication I/F
4: bus
11: omnidirectional image acquisition unit
12: image browsing control unit
13: comparison target image selection unit
14: image angle adjustment unit
15: comparison display image generation/output unit
21: omnidirectional image storage unit
22: plan view data storage unit
23: adjusted image storage unit

What is claimed is:

1. An image information generating apparatus connectable to a storage device in which omnidirectional images showing three-dimensional space and photographed at a plurality of photography positions on a plurality of photographing occasions are stored in association with coordinates indicative of the photography positions, the apparatus comprising:
a selection unit, wherein, where information requesting comparison between a first omnidirectional image and a second omnidirectional image both showing the three-dimensional space but respectively photographed on a first photographing occasion and a second photographing occasion, which are among the plurality of photographing occasions, is input, the selection unit is configured to select a second omnidirectional image whose photography position coordinates are closest to the photography position coordinates of the first omnidirectional image, from among all second omnidirectional images photographed on the second photographing occasion, which are among the omnidirectional images stored in the storage device;
an adjustment unit configured to adjust a display range and a display orientation of the selected second omnidirectional image so as to correspond to a display range and a photographing direction of the first omnidirectional image; and
an image generating unit configured to generate and output a composite image in which the second omnidirectional image whose display range and display orientation are adjusted and the first omnidirectional image are arranged for comparison.

2. The image information generating apparatus according to claim 1, wherein
where information requesting comparison between the first omnidirectional image and the second omnidirectional image both showing the three-dimensional space but respectively photographed on a first photographing date and time and a second photographing date and time is input,
the selection unit is configured to select a second omnidirectional image whose photography position coordinates are closest to the photography position coordinates of the first omnidirectional image from among all second omnidirectional images stored in the storage device and photographed on the second photographing date and time.

3. The image information generating apparatus according to claim 1, wherein the selection unit is configured to exclude the selected second omnidirectional image from a generation target of the composite image, where the photography position coordinates of the second omnidirectional image selected from among all the second omnidirectional images photographed on the second photographing occasion differ from the photography position coordinates of the first omnidirectional image by more than a predetermined distance.

4. The image information generating apparatus according to claim 3, wherein the image generating unit generates and outputs a message indicating that the second omnidirectional image of a comparison target does not exist, where the selected second omnidirectional image is excluded from the generation target of the composite image.

5. The image information generating apparatus according to claim 1, wherein the image generating unit generates an image in which the composite image in which the first omnidirectional image and the second omnidirectional image are arranged for comparison is further superimposed with an image obtained by plotting the photography position coordinates of at least one of the first omnidirectional image and the second omnidirectional image on a plan view of the three-dimensional space.

6. An image information generation method executable by an apparatus connectable to a storage device in which omnidirectional images showing three-dimensional space and photographed at a plurality of photography positions on a plurality of photographing occasions are stored in association with coordinates indicative of the photography positions, the method comprising:
where information requesting comparison between a first omnidirectional image and a second omnidirectional image both showing the three-dimensional space but respectively photographed on a first photographing occasion and a second photographing occasion, which are among the plurality of photographing occasions, is input, selecting a second omnidirectional image having photography position coordinates closest to the photography position coordinates of the first omnidirectional image from among all second omnidirectional images photographed on the second photographing occasion, which are among the omnidirectional images stored in the storage device;
adjusting a display range and a display orientation of the selected second omnidirectional image so as to correspond to a display range and a photographing direction of the first omnidirectional image; and
generating and outputting a composite image in which the second omnidirectional image whose display range and display orientation are adjusted and the first omnidirectional image are arranged for comparison.

7. A non-transitory computer-readable storage medium storing programs for causing a processor of the image information generating apparatus recited in claim 1 to execute a process of each unit of the image information generating apparatus.

8. A non-transitory computer-readable storage medium storing programs for causing a processor of the image information generating apparatus recited in claim 2 to execute a process of each unit of the image information generating apparatus.

9. A non-transitory computer-readable storage medium storing programs for causing a processor of the image information generating apparatus recited in claim 3 to execute a process of each unit of the image information generating apparatus.

10. A non-transitory computer-readable storage medium storing programs for causing a processor of the image information generating apparatus recited in claim 4 to execute a process of each unit of the image information generating apparatus.

11. A non-transitory computer-readable storage medium storing programs for causing a processor of the image information generating apparatus recited in claim 5 to execute a process of each unit of the image information generating apparatus.
